(19) United States
(12) Patent Application Publication
(10) Pub. No.: US 2019/0239666 A1
(43) Pub. Date: Aug. 8, 2019

(54) PILLOW WITH INFLATION FUNCTION

(71) Applicant: Shiyun LIU, Guangdong (CN)

(72) Inventor: Shiyun LIU, Guangdong (CN)

(21) Appl. No.: 15/889,231

(22) Filed: Feb. 6, 2018

(51) Int. Cl. A47G 9/10; B32B 7/08

(52) U.S. Cl. CPC A47G 9/1027; B32B 7/08; B32B 2250/05; B32B 2307/7265; B32B 2307/21; B32B 2307/202

(57) ABSTRACT

The present invention discloses a pillow with an inflation function, including an air pillow body within which an inflatable sponge is disposed. A first sponge sheet is connected to an outer wall at one side of the inflatable sponge through a connecting sponge. In the present invention, a first air nozzle cap, a first air nozzle, a second air nozzle, a second air nozzle cap, and an inflatable sponge are disposed. During use, the inflatable pillow can be used as an inflation tool through repeated inflation and deflation and can inflate a portable inflatable mattress, thus facilitating daily use and improving the applicability.

### BACKGROUND OF THE INVENTION

The present invention relates to the technical field of pillows, and in particular, to a pillow with an inflation function.

A pillow is a tool which is used to sleep and generally has a stuffing for comfort during sleep. A pillow generally consists of an inner pillow and a pillowcase.

However, at present, commercially available inflatable pillows are generally provided with only one air nozzle, and cannot be used to inflate a portable inflatable mattress, resulting in low applicability. During use, these pillows cannot effectively eliminate the static electricity generated by friction of hair, causing harm to the health of users. In addition, a further tying apparatus is needed when rolling up the inflatable pillow, causing inconvenience in rolling.

### BRIEF SUMMARY OF THE INVENTION

The objective of the present invention is to provide a pillow with an inflation function, to resolve the problems of an existing inflatable pillow that static electricity cannot be eliminated, the inflatable pillow cannot be used as an inflation tool, and it is inconvenient to roll up the inflatable pillow.

To achieve the foregoing objective, the present invention provides the following technical solution: A pillow with an inflation function includes an air pillow body. An inflatable sponge is disposed inside the air pillow body. A first sponge sheet is connected to an outer wall at one side of the inflatable sponge through a connecting sponge, and a second sponge sheet is connected to an outer wall at one side of the inflatable sponge adjacent to the first sponge sheet through the connecting sponge. A first air nozzle is sewn on an outer wall at one side of the air pillow body, and a second air nozzle is sewn on an outer wall at the other side of the air pillow body. A first air nozzle cap is mounted on an outer wall at one side of the first air nozzle. A second air nozzle cap is mounted on an outer wall at one side of the second air nozzle. A waterproof layer is sewn on an outer wall at one side of the air pillow body adjacent to the first air nozzle. A mesh layer and an antistatic layer are sewn and connected on an outer wall at one side of the waterproof layer far away from the air pillow body. The mesh layer is located at one side of the antistatic layer, and a conductive fiber layer is disposed between the mesh layer and the antistatic layer. A rolling-up box is mounted on an outer wall at one side of the antistatic layer. A volute spring is mounted inside the rolling-up box. A conductive fiber strip is disposed at an end of the volute spring.

Preferably, the inflatable sponge is of a cylindrical structure.

Preferably, the first sponge sheet and the second sponge sheet have the same height.

Preferably, a total of seven antistatic layers are disposed, and are uniformly disposed on an outer wall of the waterproof layer.

Preferably, a hole is provided on an outer wall of the inflatable sponge.

Compared with the prior art, the present invention has the following beneficial effects:

(1) In the present invention, a first air nozzle cap, a first air nozzle, a second air nozzle, a second air nozzle cap, and an inflatable sponge are disposed. During use, the first air nozzle cap or the second air nozzle cap is opened, the inflatable pillow body is pressed and rolled from one side, and air in the inflatable sponge is squeezed to flow out from the first air nozzle or the second air nozzle, to complete one deflation. The inflatable pillow can be used as an inflation tool through repeated inflation and deflation, and can inflate a portable inflatable mattress, thus facilitating daily use and improving the applicability.

(2) In the present invention, an antistatic layer, a conductive fiber layer, a conductive fiber strip, a volute spring, and a rolling-up box are disposed. During use, the static electricity generated by friction of hair is neutralized by a corona discharge from the conductive fiber in the conductive fiber layer. The conductive fiber strip is grounded. The static electricity is released to the ground through the conductive fiber. The conductive fiber strip is pulled out from the rolling-up box. The volute spring is pressed and compressed, to enable the conductive fiber strip to be wound on the air pillow body. In one aspect, the harm caused by static electricity to human body is effectively avoided, and the functionality of the inflatable pillow is improved. In another aspect, the inflatable pillow can be wound to reduce the volume for easy portability.

(3) In the present invention, a first sponge sheet, a connecting sponge, and a second sponge sheet are disposed. The first sponge sheet and the second sponge sheet are used to isolate adjacent inflatable sponges. In one aspect, wear between the inflatable sponges is prevented, the service life is prolonged, and the stability of inflation is ensured. In another aspect, an additional support can be provided for the inflatable pillow, so as to prevent an excessively soft pillow from harming the cervical vertebrae.

### BRIEF DESCRIPTION OF THE DRAWINGS

FIG. 1 is a top view according to the present invention;

FIG. 2 is a front view according to the present invention; and

FIG. 3 is an enlarged view of a position A according to the present invention.

In the figures: 1—Air pillow body, 2—First air nozzle cap, 3—First air nozzle, 4—Second air nozzle, 5—Second air nozzle cap, 6—First sponge sheet, 7—Connecting sponge, 8—Second sponge sheet, 9—Inflatable sponge, 10—Waterproof layer, 11—Mesh layer, 12—Antistatic layer, 13—Conductive fiber layer, 14—Conductive fiber strip, 15—Volute spring, and 16—Rolling-up box.

### DETAILED DESCRIPTION OF THE INVENTION

The technical solutions according to the embodiments of the present invention are clearly and thoroughly described with reference to the accompanying drawings in the embodiments of the present invention. The described embodiments are merely exemplary ones, but are not all the embodiments of the present invention. Based on the embodiments of the present invention, all other embodiments derived by persons of ordinary skill in the art without any creative efforts shall fall within the protection scope of the present invention.

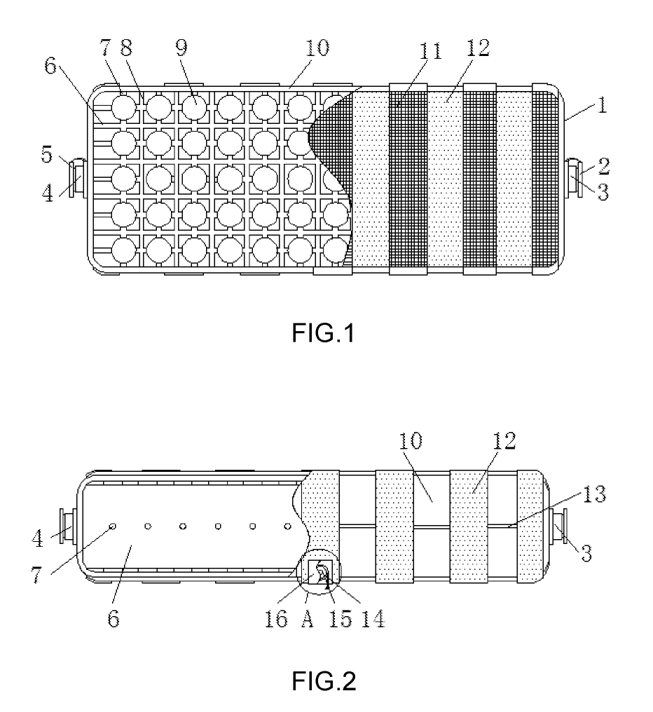

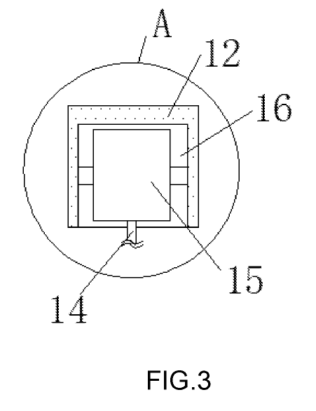

Referring to FIG. 1 to FIG. 3, the present invention provides the following technical solution: A pillow with an inflation function includes an air pillow body 1. An inflatable sponge 9 is disposed inside the air pillow body 1 for automatic inflation. A first sponge sheet 6 is connected to an outer wall at one side of the inflatable sponge 9 through a connecting sponge 7, and a second sponge sheet 8 is connected to an outer wall at one side of the inflatable sponge 9 adjacent to the first sponge sheet 6 through the connecting sponge 7, to prevent the inflatable sponge 9 from wear, prolong the service life, and ensure the stability of inflation. A first air nozzle 3 is sewn on an outer wall at one side of the air pillow body 1, and a second air nozzle 4 is sewn on an outer wall at the other side of the air pillow body 1, to achieve inflation and deflation. A first air nozzle cap 2 is mounted on an outer wall at one side of the first air nozzle 3, and a second air nozzle cap 5 is mounted on an outer wall at one side of the second air nozzle 4, to prevent air from flowing out. A waterproof layer 10 is sewn on an outer wall at one side of the air pillow body 1 adjacent to the first air nozzle 3, to prevent water from entering the inflatable sponge 9 and affecting the inflation. A mesh layer 11 and an antistatic layer 12 are sewn on an outer wall at one side of the waterproof layer 10 far away from the air pillow body 1. The mesh layer 11 is located on one side of the antistatic layer 12, and a conductive fiber layer 13 is disposed between the mesh layer 11 and the antistatic layer 12. The mesh layer 11 stores grease and dandruff from the head to prevent them from falling on the bed. A rolling-up box 16 is mounted on an outer wall at one side of the antistatic layer 12. A volute spring 15 is mounted inside the rolling-up box 16, and a conductive fiber strip 14 is disposed at an end of the volute spring 15. In one aspect, grounding is achieved, and static electricity is eliminated. In another aspect, it is convenient to roll up and tie the air pillow body 1.

To provide more comfort in use, in this embodiment, preferably, the inflatable sponge 9 is of a cylindrical structure.

To avoid wear between adjacent inflatable sponges 9, in this embodiment, preferably, the first sponge sheet 6 and the second sponge sheet 8 have the same height.

To thoroughly eliminate the static electricity in hair, in this embodiment, preferably, a total of seven antistatic layers 12 are disposed and are uniformly disposed on an outer wall of the waterproof layer 10.

To ensure that the inflatable sponge 9 can be inflated and deflated more rapidly, in this embodiment, preferably, a hole is provided on an outer wall of the inflatable sponge 9.

The working principle and use procedure of the present invention are as follows: During use, the first air nozzle cap 2 or the second air nozzle cap 5 is opened, the inflatable pillow body 1 is pressed and rolled from one side, and air in the inflatable sponge 9 is squeezed to flow out from the first air nozzle 3 or the second air nozzle 4, to complete one deflation. When the air pillow body 1 is no longer pressed and rolled by hands, the inflatable sponge 9 automatically springs back, restores the original shape, and automatically sucks air into the air pillow body 1. The first air nozzle cap 2 or the second air nozzle cap 5 is then tightly screwed. During the use by a user, the static electricity generated by friction of hair is neutralized by a corona discharge from the conductive fiber in the conductive fiber layer 13, so that the harm caused by static electricity to human body is reduced. The conductive fiber strip 14 is grounded. The static electricity is released to the ground through the conductive fiber. The air pillow body 1 is rolled up from one side when it is not used. When air in the inflatable sponge 9 is completely removed, the first air nozzle cap 2 or the second air nozzle cap 5 is screwed tightly. The conductive fiber strip 14 is pulled out from the rolling-up box 16. The volute spring 15 is pressed and compressed, to enable the conductive fiber strip 14 to be wound on the air pillow body 1, so that the volume of the air pillow body 1 is reduced for easy portability.

Although the embodiments of the present invention have been shown and disclosed, a person of ordinary skill in the art may understand that various changes, modifications, replacements, and variations may be made to these embodiments without departing from the principle and spirit of the present invention. The scope of the present invention is defined by the appended claims and equivalents thereof.

What is claimed is:

1. A pillow with an inflation function, comprising an air pillow body (1), wherein an inflatable sponge (9) is disposed inside the air pillow body (1), a first sponge sheet (6) is connected to an outer wall at one side of the inflatable sponge (9) through a connecting sponge (7), a second sponge sheet (8) is connected to an outer wall at one side of the inflatable sponge (9) adjacent to the first sponge sheet (6) through the connecting sponge (7), a first air nozzle (3) is sewn on an outer wall at one side of the air pillow body (1), a second air nozzle (4) is sewn on an outer wall at the other side of the air pillow body (1), a first air nozzle cap (2) is mounted on an outer wall at one side of the first air nozzle (3), a second air nozzle cap (5) is mounted on an outer wall at one side of the second air nozzle (4), a waterproof layer (10) is sewn on an outer wall at one side of the air pillow body (1) adjacent to the first air nozzle (3), a mesh layer (11) and an antistatic layer (12) are sewn on an outer wall at one side of the waterproof layer (10) far away from the air pillow body (1), the mesh layer (11) is located on a side of the antistatic layer (12), a conductive fiber layer (13) is disposed between the mesh layer (11) and the antistatic layer (12), a rolling-up box (16) is mounted on an outer wall at one side of the antistatic layer (12), a volute spring (15) is mounted inside the rolling-up box (16), and a conductive fiber strip (14) is disposed at an end of the volute spring (15).

2. The pillow with the inflation function according to claim 1, wherein the inflatable sponge (9) is of a cylindrical structure.

3. The pillow with the inflation function according to claim 1, wherein the first sponge sheet (6) and the second sponge sheet (8) have the same height.

4. The pillow with the inflation function according to claim 1, wherein a total of seven antistatic layers (12) are disposed and are uniformly disposed on an outer wall of the waterproof layer (10).

5. The pillow with the inflation function according to claim 1, wherein a hole is provided on an outer wall of the inflatable sponge (9).
